(19) United States
(12) Patent Application Publication
(10) Pub. No.: US 2002/0122228 A1
(43) Pub. Date: Sep. 5, 2002

(54) Network and method for propagating data packets across a network

(76) Inventors: Yigal Rappaport, Holon (IL); Shlomo Reches, Petah Tiqva (IL); Gidi Navon, Tel Aviv (IL)

Correspondence Address: MERCHANT & GOULD PC, P.O. BOX 2903, MINNEAPOLIS, MN, 55402-0903, US

(21) Appl. No.: 09/797,047

(22) Filed: Mar. 1, 2001

(51) Int. Cl. H04J 14/02; H04J 14/08

(52) U.S. Cl. 359/135; 359/124

(57) ABSTRACT

Network element and a method for propagating a data packet across a network. The network configured to accommodate a plurality of optical paths. At least one optical path includes a packet switched path and at least one optical path includes a circuit switched path. An optical path can include both a circuit switched path and an packet switched path. The distribution of data packet among the optical paths is based upon at least one of the following parameters: (i) the data packet flow; (ii) the ingress network element that received the data packet; (iii) the destination of the data packet; (iv) at least one predefined criterion. Usually, the selection of a selected optical path is preceded by a step of monitoring the propagation of data packets flows across the optical paths and determining whether the data packet flow fulfilled a predefined criterion. The selection is based upon the determination.

A predefine criterion can relate to the data packet flow, to the optical path, or to predefined user or system administrator policies, such as traffic engineering or traffic policing.

### FIELD OF THE INVENTION

The present invention relates to network routing and especially to a network and a method for propagating data packets across WDM network that are configured to support both packet switched paths and circuit switched paths.

### BACKGROUND OF THE INVENTION

Packet switching schemes allow better utilization of a networks bandwidth but involves packet processing that eventually limits the overall bandwidth in comparison to circuit switched routing. Circuit switched schemes allows to handle larger volumes of data packet traffic but does not utilize the available bandwidth efficiently.

There is a need to combine both types of routing and provide both improved bandwidth utilization for low volume data packet flows and offer large bandwidth to high volume data packet flows.

### SUMMARY OF THE INVENTION

The invention provides a network and a method for propagating data packets across network that support both packet switched routing and circuit switched routing. Conveniently, in order to prevent data packet disorder, data packets that belong to a flow of a single flow class are provided to the same optical path. At least one optical path includes a packet switched path and at least one optical path includes a circuit switched path. An optical path can include both a circuit switched path and an packet switched path. The distribution of data packet among the optical paths is based upon at least one of the following parameters: (i) the data packet flow; (ii) the ingress network element that received the data packet; (iii) the destination of the data packet; (iv) at least one predefined criterion. Usually, the selection of a selected optical path is preceded by a step of monitoring the propagation of data packets flows across the optical paths and determining whether the data packet flow fulfilled a predefined criterion. The selection is based upon the determination.

A predefine criterion can relate to the data packet flow, to the optical path, or to predefined user or system administrator policies, such as traffic engineering or traffic policing. For example, a predefined criterion can be related to the data packet flow bandwidth, data packet flow volume, data packet flow delay sensitivity, data packet flow priority; data packet flow source, and data packet source destination, an optical path available bandwidth, an optical path delay, an optical path length, an optical path cost; and an optical path jitter.

Conveniently, if the selected optical path has a packet switched path, the provision of the data packet to the selected optical path further involves the generation of a label being indicative of the packet switched path, at the beginning of the optical switched path of the selected optical path; the attachment of the label to the data packet, the processing of the label at each network element along the packet switched path and forwarding the label and the data packet accordingly. If the selected optical path has a circuit switched path, the provision of the data packet involves changing the wavelength of the data packet to a predefined wavelength associated with the circuit switched path, at the beginning of the circuit switched path; and at each network element along the circuit switched path detecting the wavelength of the data packet and forwarding the data packet accordingly.

Only for convenience of explanation it is assumed that the predefined criteria relates to the volume of the data packet flow, and that data packet flows that exceed a predefined volume threshold are provided to circuit switched paths.

### BRIEF DESCRIPTION OF THE DRAWINGS

While the invention is pointed out with particularity in the appended claims, other features of the invention are disclosed by the following detailed description taken in conjunction with:

FIG. 1 is a schematic diagram illustrating a WDM network that is interconnected to IP networks, according to a preferred embodiment of the invention;

FIG. 2 is a schematic diagram illustrating a portion of an optical network element of the WDM network, according to a preferred embodiment of the invention;

FIG. 3 is a schematic diagram illustrating an input port of an optical network element of the WDM network, according to a preferred embodiment of the invention;

FIG. 4 is a schematic diagram illustrating a portion of an input port of an optical network element of the WDM network, according to a preferred embodiment of the invention;

FIG. 5 is a schematic diagram illustrating an output port of an optical network element of the WDM network, according to a preferred embodiment of the invention;

FIG. 6 is a schematic diagram illustrating a portion of an input port of an optical network element of the WDM network, according to another embodiment of the invention;

FIGS. 7a and 7b are flow chart diagrams illustrating a method for preventing a disorder of a sequence of data packets traversing a network, according to embodiments of the invention;

FIG. 8 is a flow chart diagram illustrating a method for local path determination for preventing a disorder of a sequence of data packets traversing a network, according to an embodiment of the invention;

FIG. 9 is a flow chart diagram illustrating a method for propagating data packet flows over the WDM network, according to a preferred embodiment of the invention; and

FIG. 10 is a schematic diagram illustrating a portion of an optical network element of the WDM network, according to another preferred embodiment of the invention.

### DETAILED DESCRIPTION OF THE DRAWINGS

The invention provides a method for propagating data packets across optical paths. At least one optical path includes a packet switched path and at least one optical path includes a circuit switched path. An optical path can include both a circuit switched path and an packet switched path. The distribution of data packet among the optical paths is based upon at least one of the following parameters: (i) the data packet flow; (ii) the ingress network element that received the data packet; (iii) the destination of the data packet; (iv) at least one predefined criterion. Usually, the selection of a selected optical path is preceded by a step of monitoring the propagation of data packets flows across the optical paths and determining whether the data packet flow fulfilled a predefined criterion. The selection is based upon the determination.

The invention provides a method for propagating data packets wherein a predefine criterion can relate to the data packet flow, to the optical path, or to predefined user or system administrator policies, such as traffic engineering or traffic policing. For example, a predefined criterion can be related to the data packet flow bandwidth, data packet flow volume, data packet flow delay sensitivity, data packet flow priority; data packet flow source, and data packet source destination, an optical path available bandwidth, an optical path delay, an optical path length, an optical path cost; and an optical path jitter.

The invention provides a method for propagating data packets wherein if the selected optical path has a packet switched path, the provision of the data packet to the selected optical path further involves the generation of a label being indicative of the packet switched path, at the beginning of the optical switched path of the selected optical path; the attachment of the label to the data packet, the processing of the label at each network element along the packet switched path and forwarding the label and the data packet accordingly.

The invention provides a method for propagating data packets wherein if the selected optical path has a circuit switched path, the provision of the data packet involves changing the wavelength of the data packet to a predefined wavelength associated with the circuit switched path, at the beginning of the circuit switched path; and at each network element along the circuit switched path detecting the wavelength of the data packet and forwarding the data packet accordingly.

The invention provides a method for propagating data packet flows over a network, the network including of a plurality of nodes interconnected by a plurality of optical links, the method including the steps of: establishing packet switched paths and circuit switched paths across the network; monitoring flows propagating over the network and determining a volume of the flow; and providing flows that exceed a predefined volume threshold to circuit switched paths, providing flows that do not exceed the predefined threshold to packet switched paths.

The invention provides a method for propagating data packets across a network wherein the step of establishing circuit switched paths further includes the step of allocating wavelengths to circuits switch paths.

The invention provides a method for propagating data packets across a network wherein the step of providing flows further includes the steps of: analyzing incoming data packets to determine to which packet switched path to provide the data packet; generating a label being indicative of the packet switched path; attaching the label to the data packet; and at each network element along the optical path of the packet switched path processing the label and forwarding the label and the data packet accordingly.

The invention provides a method for propagating data packets across a network further including a step of updating a flow volume indication to reflect the reception of a data packet of the flow.

The invention provides a method for propagating data packets across a network wherein the step of providing further includes the steps of: analyzing incoming data packets to determine to which circuit switched path to provide the data packet; changing the wavelength of the data packet to a predefined wavelength associated to the circuit switched path; and at each network element along the circuit switched path detecting the wavelength of the data packet and forwarding the data packet accordingly.

The invention provides a method for propagating data packets across a network further including a step of configuring configurable network elements to support packet switched routing or support circuit switched routing in view of the load on optical paths across the network.

The invention provides a method for propagating data packets across a network further including a step of balancing the load between optical paths.

The invention provides a method for propagating data packets across a network wherein each packet switched path includes of a plurality of local paths across network element along the packet switched path; and wherein the method further including a step of locally selecting, at each network element along the packet switched path, a local path across the network element.

The invention provides a method for propagating data packets across a network further includes a step of balancing the load among local paths across a network element along the selected packet switched path.

The invention provides a method for propagating a data packet from a ingress network element to an egress network element in a wavelength division multiplexing (WDM) network, the method including the steps of: establishing packet switched paths and optical channel trails between the ingress and the egress network elements, associating a label to each packet switched path and associating a wavelength to each optical channel trail; initializing flow volume indications, each being indicative of the volume of a flow from ingress network elements to egress network elements; receiving a data packet at the ingress network element; analyzing the data packet to determine the to which path to provide the data packet; and providing data packet of flows that exceed a predefined volume threshold to optical channel trails and providing flows that do not exceed the predefined threshold to packet switched paths.

The invention provides a method for propagating data packets across a network further includes a step of generating and storing at each network element a forwarding table for reflecting the association of labels to packet switched paths and for reflecting the association of wavelength to optical channel trails.

The invention provides a method for propagating data packets across a network further including the steps of: analyzing incoming data packets to determine to which optical channel trail to provide the data packet; changing the wavelength of the data packet to a predefined wavelength associated to the optical channel trail; and at each network element along the optical channel trail detecting the wavelength of the data packet and forwarding the data packet according to the wavelength of the data packet.

The invention provides a method for propagating data packets across a network further includes of a steps of converting the combined optical signal to a combined electrical signal and converting the combined electrical signal to a combined optical signal at each network element.

The invention provides a method for propagating data packets across a network wherein the step of providing flows further includes the steps of: analyzing incoming data packets to determine to which packet switched path to provide the data packet; generating a label being indicative of the packet switched path; attaching the label to the data packet to provide a combined optical signal representative of the label and of the data packet; and optically transmitting the combined optical signal across the packet switched path; at each network element along the packet switched path detecting the label and forwarding the combined optical signal according to the content of the label.

The invention provides a method for propagating data packets across a network further includes a step of swapping labels at each network element along the packet switched path.

The invention provides a method for propagating data packets across a network further including a step of configuring configurable network elements to support packet switched routing or support circuit switched routing in view of the load on optical paths across the network.

The invention provides a method for propagating data packets across a network further including a step of balancing the load between optical path.

The invention provides a method for propagating data packets across a network wherein each packet switched path includes of a plurality of local paths across network element along the packet switched path; and wherein the method further including a step of locally selecting, at each network element along the packet switched path, a local path across the network element.

The invention provides a method for propagating data packets across a network further includes a step of balancing the load among local paths across a network element along the selected packet switched path.

The invention provides a method for propagating a data packet from a ingress network element to an egress network element in a wavelength division multiplexing (WDM) network, the method including the steps of: establishing packet switched paths and optical circuit switched paths between the ingress and the egress network elements, associating a label to each packet switched path and associating a wavelength to each packet switched path; initializing flow volume indications, each being indicative of the volume of a flow from ingress network elements to egress network elements; receiving a data packet at the ingress network element; analyzing the data packet to determine the to which optical path to provide the data packet; and providing data packet of flows that exceed a predefined volume threshold to circuit switched paths, providing flows that do not exceed the predefined threshold to packet switched paths.

The invention provides a method for propagating data packets across a network further includes a step of generating and storing at each network element a forwarding table for reflecting the association of labels to packet switched paths and for reflecting the association of wavelength to packet switched paths.

The invention provides a method for propagating data packets across a network further including the steps of: analyzing incoming data packets to determine to which circuit switched path to provide the data packet; changing the wavelength of the data packet to a predefined wavelength associated to the circuit switched path; and at each network element along the circuit switched path detecting the wavelength of the data packet and forwarding the data packet according to the wavelength of the data packet.

The invention provides a method for propagating data packets across a network further includes of a steps of converting the combined optical signal to a combined electrical signal and converting the combined electrical signal to a combined optical signal at each network element along the optical path.

The invention provides a method for propagating data packets across a network wherein the step of providing flows further includes the steps of: analyzing incoming data packets to determine to which packet switched path to provide the data packet; generating a label being indicative of the packet switched path; attaching the label to the data packet to provide a combined optical signal representative of the label and of the data packet; and optically transmitting the combined optical signal across the packet switched path; at each network element along the packet switched path detecting the label and forwarding the combined optical signal according to the content of the label.

The invention provides a method for propagating data packets across a network further includes a step of swapping labels at each network element along the packet switched path.

The invention provides a method for propagating data packets across a network further including a step of configuring configurable network elements to support packet switched routing or support circuit switched routing in view of the load on optical paths across the network.

The invention provides a method for propagating data packets across a network further including a step of balancing the load between optical path.

The invention provides a method for propagating data packets across a network wherein each packet switched path includes of a plurality of local paths across network element along the packet switched path; and wherein the method further including a step of locally selecting, at each network element along the packet switched path, a local path across the network element.

The invention provides a method for propagating data packets across a network further includes a step of balancing the load among local paths across a network element along the selected packet switched path.

The invention provides a network including a plurality of egress network elements, ingress network elements and intermediate network elements, the network elements are interconnected by a optical links, wherein the network is configured to accommodate optical paths such as packet switched paths and circuit switched paths from ingress network elements to egress network elements, the network including at least one network control entity configured to establish optical path such as packet switched paths and circuit switched paths from ingress network elements to egress network elements; wherein each ingress network element includes: a flow monitoring entity configured to monitor flows propagating over optical paths starting at the ingress network element; and a local control component configured to provide data packets that belong to data packet flows that exceed a predefined volume threshold to circuit switched paths, and providing flows that do not exceed the predefined threshold to packet switched paths.

The invention provides a network wherein the network control entity is configured to allocate wavelengths to circuits switch paths.

The invention provides a network wherein the local control component is further configured to: (a) analyze incoming data packets to determine to which packet switched path to provide the data packet; (b) generate a label being indicative of the packet switched path; (c) attach the label to the data packet; and wherein each intermediate network element along a packet switched path is configured to process the label and to send forward the label and the data packet across the intermediate network element accordingly.

The invention provides a network wherein the flow monitoring entity updates a flow volume indication to reflect the reception of a data packet of the flow.

The invention provides a network wherein the local control component is further configured to: (a) analyze incoming data packets to determine to which circuit switched path to provide the data packet; (b) change the wavelength of the data packet to a predefined wavelength associated to the circuit switched path; and wherein each intermediate network element along a packet switched path is configured to detect the wavelength of the data packet and forward the data packet accordingly.

The invention provides a network wherein ingress network elements are further adapted to configure network elements to support packet switched routing or support circuit switched routing in view of the load on optical paths across the network.

The invention provides a network wherein ingress network elements are further configured to balance traffic load between optical paths starting at the ingress network elements.

The invention provides a network wherein each packet switched path includes of a plurality of local paths across network elements along the packet switched path; and wherein each network element has a local control component for selecting a local path across the network element.

The invention provides a network wherein each network element is further configured to balance traffic load among local paths across the network element.

It should be noted that the particular terms and expressions employed and the particular structural and operational details disclosed in the detailed description and accompanying drawings are for illustrative purposes only and are not intended to in any way limit the scope of the invention as described in the appended claims.

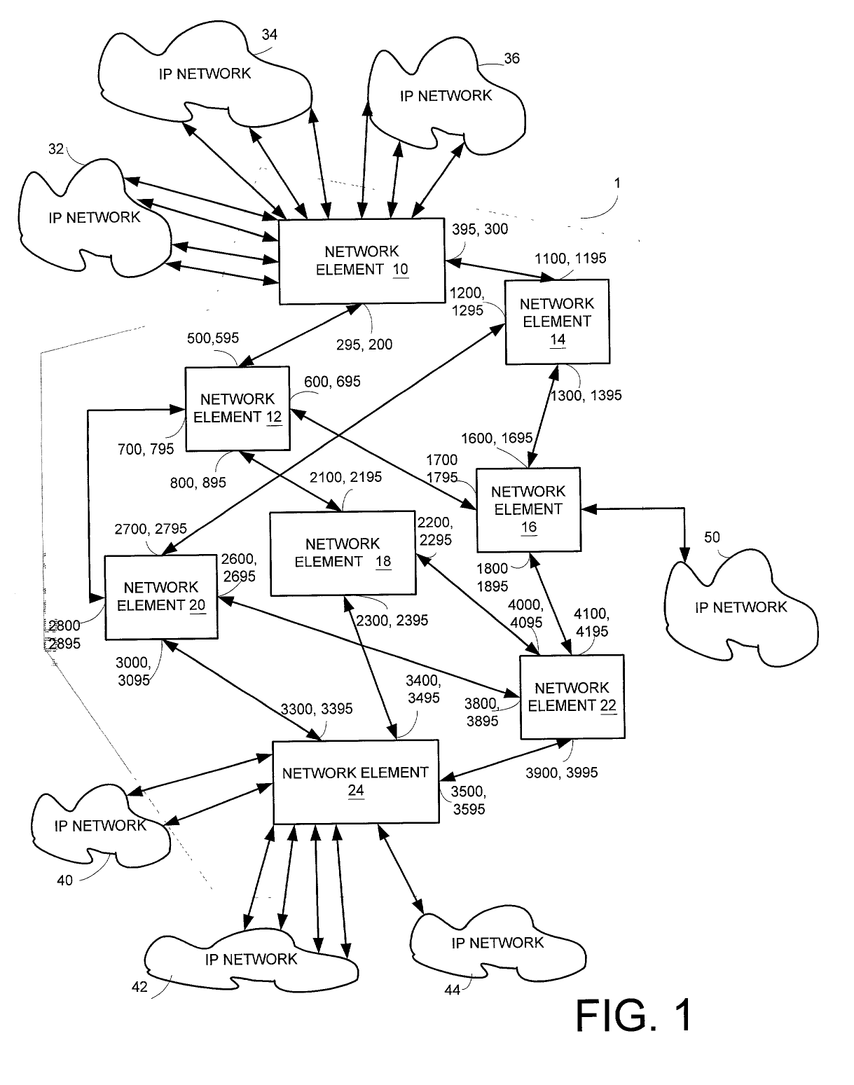

FIG. 1 illustrates a wavelength division multiplexing (WDM) network 1 that is interconnected to IP networks 32, 34, 36, 40, 42, 44 and 50, according to a preferred embodiment of the invention. WDM network includes network elements 10, 12, 14, 16, 18, 20, 22 and 24 that are partially interconnected to each other by optical links and are configured to exchange WDM optical signals, and control, status and routing information. Network 1 further includes a central system management unit (not shown), although it can be managed by distributed management schemes.

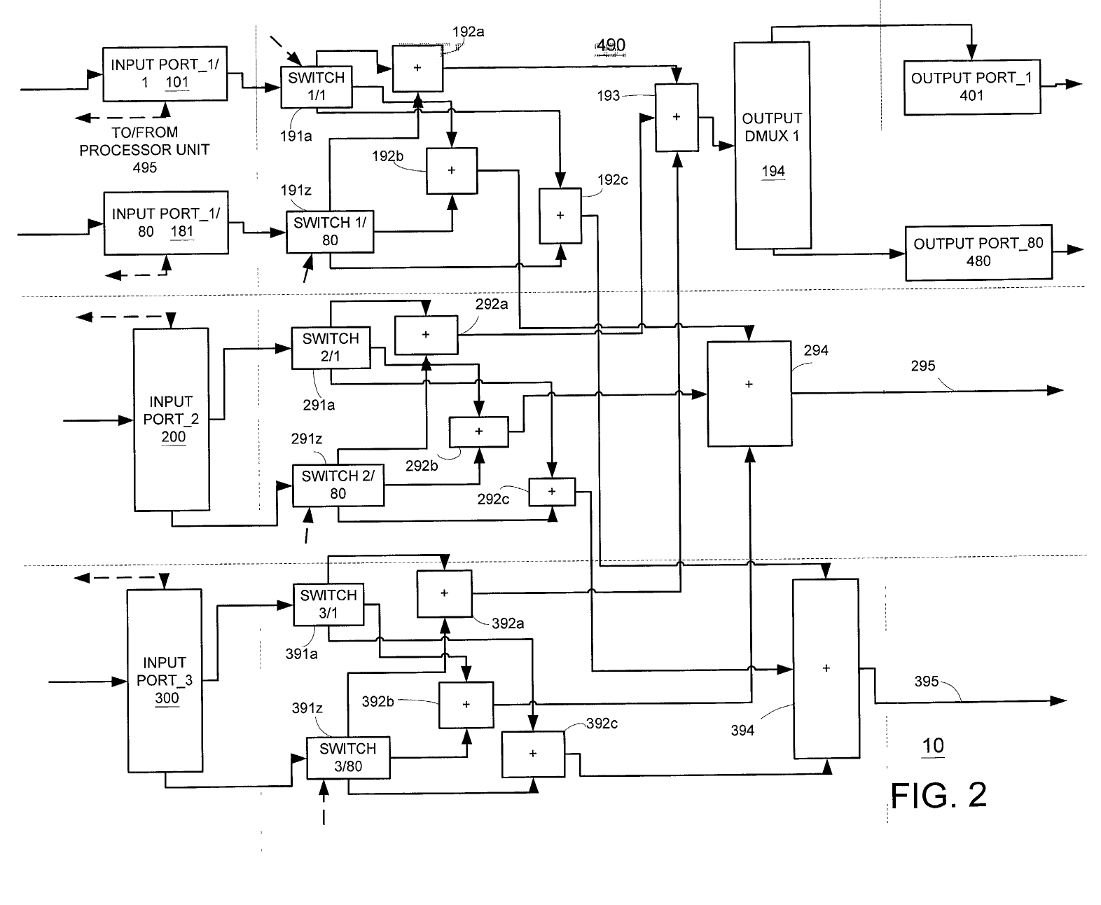

Network element 10 includes a network control component (not shown), for establishing optical path across a network including the network element. The network control element is coupled either to the central system management unit or to network components of other network elements. Network element 10 further includes a local control component, such as network processors and network unit 495 illustrated at FIG. 2-6.

Network elements of network 1 have two types of input/output (I/O) ports. I/O ports of the first type of port are configured to exchange signals with routers from IP networks, such as single wavelength signals. I/O ports of the second type are configured to exchange WDM signals with other network elements of network 1. For convenience of explanation, each of the second type I/O port is referenced by two numbers, a first denoting the input portion of the I/O port and the second denoting the output portion of the I/O port.

Network element 10 has eighty input/output (I/O) ports for exchanging single wavelength signals with IP networks 32, 34 and 26. These eighty I/O are shown at FIG. 2 as INPUT PORT_1/1-INPUT PORT_1/80 101-180 and OUTPUT PORT_1-OUTPUT PORT_80 401-480. Network element 10 has two I/O ports for receiving and transmitting WDM optical signals of up to eighty wavelengths. These two I/O ports are shown at FIG. 2 as INPUT PORT_2 200, INPUT PORT_3 300, and output ports 295 and 395.

Network element 24 has eighty input/output (I/O) ports for exchanging single wavelength signals with IP networks 40, 42 and 44. These eighty I/O are analogues to INPUT PORT_1/1-INPUT PORT_1/80 101-180 and OUTPUT PORT_1-OUTPUT PORT_80 401-480 of network element 10. Network element 24 has three I/O ports (3300, 3395), (3400, 3495) and (3500, 3595) for receiving and transmitting WDM optical signals of up to eighty wavelengths. Network element 12 has four I/O ports (500, 595), (600, 695), (700, 795) and (800, 895) for receiving and transmitting WDM optical signals of up to eighty wavelengths. Network element 14 has three I/O ports (1100, 1195), (1200, 1295) and (1300, 1395) for receiving and transmitting WDM optical signals of up to eighty wavelengths. Network element 16 has three I/O ports (1600, 1695), (1700, 1795) and (1800, 1895) for receiving and transmitting WDM optical signals of up to eighty wavelengths. Network 16 has eighty I/O ports 1401-1480 and 1501-1580 for exchanging single wavelength signals with IP network 50. Network element 18 has three I/O ports (2100, 2195), (2200, 2295) and (2300, 2395) for receiving and transmitting WDM optical signals of up to eighty wavelengths. Network element 20 has four I/O ports (2600, 2695), (2700, 2795), (2800, 2895) and (3000, 3095) for receiving and transmitting WDM optical signals of up to eighty wavelengths. Network element 22 has four I/O ports (3800, 3895), (3900, 3995), (4000, 4095) and (4100, 4195) for receiving and transmitting WDM optical signals of up to eighty wavelengths.

I/O ports (500, 595), (600, 695), (700, 795), (800, 895), (1100, 1195), (1200, 1295), (1300, 1395), (1600, 1695), (1700, 1795), (1800, 1895), (2100, 2195), (2200, 2295), (2300, 2395), (2600, 2695), (2700, 2795), (2800, 2895), (3000, 3095), (3300, 3395), (3400, 3495), (3500, 3595), (3800, 3895), (3900, 3995), (4000, 4095) and (4100, 4195) are analogues to I/O ports (300, 395) and (200, 295) of network element 10.

I/O ports (500, 595), (600, 695), (700, 795), (800, 895), (1100, 1195), (1200, 1295), (1300, 1395), (3300, 3395), (3400, 3495), (3500, 3595), (400, 4095) and (4100, 4195) are coupled to I/O ports (295, 200), (1700, 1795), (2800, 2895), (2100, 2194), 300, 395), (2700, 2795), (1600, 1695), (3000, 3095), 2300, 2395), (3900, 3995), (2200, 2295) and (1800, 1895) respectively.

Optical paths across network 1 are established and maintained by either a central or distributed management schemes. An optical path is characterized by a selected input ports and output ports of network elements of network 1. For example, a first optical path from network element 1 to network element 42 is characterized by output port 295 and the following pairs of ports: (input port 500, output port 695), (input port 1700, output port 1895), (input port 4100, output port 3395).

When a router from an IP networks send data packets that is destined to a router of another IP network, the data packet is received at an ingress network element of the WDM network, is sent along an optical path until reaching an egress network elements to be provided to the other IP network. For example, assuming that a router from IP network 34 sends a data packet to another router of IP network 44. The data packet includes an IP header that indicates what are the source and the destination of the data packet. The data packet arrives to network element 10, acting as an ingress network element, interconnected to IP network 34. Network element 10 will perform an IP forwarding process to select an optical path across the WDM network that ends at network element 24. Assuming that the selected optical path is the first optical path then the data packet is propagates (i) over a local path of network element 10 to output port 295; (ii) from output port 295 to input port 500 of network element 12; (iii) over a local path across network element 12 to output port 695; (iv) from output port 695 to input port 1700 of network element 16; (v) over a local path across network element 16 to output port 1895; (vi) from output port 1895 to input port 4100 of network element 22; (vii) over a local path across network element 22 to output port 3395; (viii) from output port 3395 to input port 3500 of network element 24; (ix) over a local path across network element 24 to the I/O port interconnected to the other router of IP network 44.

Referring to FIG. 2 illustrating a portion 10″ of an optical network element 10 according to a preferred embodiment of the invention. Network element 10 includes a second set of input ports INPUT PORT_2 200 and INPUT PORT_3 300, a first set of input ports INPUT PORT_1/1-INPUT PORT_1/80 101-181, a first set of output ports OUTPUT PORT_1-OUTPUT PORT_80 401-480, a second set of output ports 295 and 395, interconnection unit 490 and processor unit 495.

INPUT PORT_2 200 and output port 295 are coupled to network element 12. INPUT PORT_3 300 and output port 395 are coupled to network element 14. For convenience of explanation the bi-directional links interconnecting IP networks 32, 34 and 36 to network element are illustrated as INPUT PORT_1/1-INPUT PORT_1/80 101-181 and output ports OUTPUT PORT_1-OUTPUT PORT_80 401-480.

Bi-directional dashed arrows pointed to all input ports represent control and status information exchanged between the input ports and processor unit 495 (not shown). The control and status information includes requests from input ports to processor unit 495 to generate and provide intermediate optical signals over interconnect unit 490 and to select a local path out of a group of local paths available to a data packet processed by the network processor that generated the request, and includes acceptance signals from processor unit 495.

Unidirectional dashed arrows pointed to all spatial switched represent control signals from processor unit 495 to configure the switches to provide incoming intermediate optical signals to the selected output port.

Each port of INPUT PORT_1/1-INPUT PORT_1/80 101-180 is configured to: (a) Receive a single optical wavelength input signal or an electrical input signal. Conveniently, this is a single wavelength optical signal, such as a SONET signal or Ethernet signals. SONET signal include a SONET header and a plurality of data packets. (b) If a single wavelength optical signal is received, convert it to an electrical input signal. (c) Check the electrical input signal and for each data packet of the electrical input signal determine to which local path across the network element to send the data packet. (d) Convert each data packet to an input optical intermediate signal and provide it to the selected local path. Usually, the network processor of the input port selects the selected local path and sends a transmission request to processor unit 495. Processor unit 495 is configured to (a) receive transmission requests from all network processors within each input port, (b) determines which request to accept, and (c) notify network processors within the input ports which transmission requests are accepted. The selection prevents contentions. Conveniently, processor 495 includes a plurality of arbitration units, each arbitration unit is associated with a single local path. Preferably, each arbitration unit implements round-robin arbitration scheme.

According to a preferred embodiment of the invention, when network processor selected the local path for a data packet, the data packet is stored in a queue out of at least one associated with the selected local path. The network processor generates a transmission request from processor 495 when the queue is at least partially full.

Network element 10 is configured to handle eighty different wavelengths. The wavelength of an optical intermediate signal sent to one of the first set of ports determines the output port. For example, optical intermediate signals having a k'th wavelength out of the eighty possible wavelengths will be provided to the k'th output port out of the first set of output ports.

Each input port of input ports 200 and 300 is configured to: (a) Receive a multiwavelength input signal, the multiwavelength signal can include up to eighty wavelengths. (b) De-multiplex the multiwavelength input signal to a plurality of single wavelength input signals. (c) Convert each single wavelength input signal to an electrical input signal, the electrical input signal includes at least one data packet. (d) Check the electrical input signal and for each data packet of the electrical input signal determine to which local path across the network element to send the data packet. (d) Convert each data packet to an input optical intermediate signal and provide it to the selected local path.

Each of output ports 295 and 395 is adapted to output multiwavelength output signals to network elements 12 and 14 respectively.

Each of outputs OUTPUT PORT_1-OUTPUT PORT_80 401-480 is configured to: (a) Receive an optical intermediate signal. (b) Convert the output optical intermediate signal to a single wavelength signal, such as SONET signals, and (c) Transmit the single wavelength signal.

Interconnect unit 490 is coupled to input ports 101-181, 200 and 300 to output ports 401-480, 295 and 395. Interconnection unit 490 is configured to provide each selected output port the optical intermediate signals destined to the selected output port. Interconnect unit 490 includes spatial switches SWITCH_1/1-SWITCH_1/80 191a-191z, SWITCH_2/1-SWITCH_2/80 291a-291z and SWITCH_3/1-SWITCH_3/80 391-391z, optical combiners 192a-192c, optical combiners 292a-292c, optical combiners 392a-392c, optical combiners 193, 294 and 394 and output demultiplexer 194.

Each switch of SWITCH_1/1-SWITCH_1/80 receives an intermediate optical signal from INPUT PORT_1/1-INPUT PORT_1/80 respectively and in response to a control signals from processor unit 495 (not shown) provide the intermediate optical switch to one out of optical combiners 191a-191c. Intermediate optical signals destined to one of OUTPUT PORT_1-OUTPUT PORT_80 are provides to combiner 191a, and via combiner 192a to output demultiplexer 194. Output demultiplexer 194 provides an intermediate optical signal of the k'th wavelength to the k'th output port out of OUTPUT PORT_1-OUTPUT PORT_80, 0<k<81. Intermediate optical signals destined to output port 295 are provided to via combiner 191b and combiner 294 to output port 295. Intermediate optical signals destined to output port 395 are provided to via combiner 191c and combiner 394 to output port 295.

Each switch of SWITCH_2/1-SWITCH_2/80 receives an intermediate optical signal from one of the eighty outputs of input port 200 and in response to a control signals from processor unit 495 provide the intermediate optical switch to one out of optical combiners 292a-292c. Intermediate optical signals destined to one of OUTPUT PORT_1-OUTPUT PORT_80 are provides to combiner 292a, and via combiner 193 to output demultiplexer 194. Intermediate optical signals destined to output port 295 are provided to via combiner 292b and combiner 294 to output port 295. Intermediate optical signals destined to output port 395 are provided to via combiner 292c and combiner 394 to output port 295.

Each switch of SWITCH_3/1-SWITCH_3/80 receives an intermediate optical signal from one of the eighty outputs of input port 300 and in response to a control signals from processor unit 495 (not shown) provide the intermediate optical switch to one out of optical combiners 393a-393c. Intermediate optical signals destined to one of OUTPUT PORT_1-OUTPUT PORT_80 are provides to combiner 392a, and via combiner 193 to output demultiplexer 194. Intermediate optical signals destined to output port 295 are provided to via combiner 392b and combiner 294 to output port 295. Intermediate optical signals destined to output port 395 are provided to via combiner 392c and combiner 394 to output port 295.

A single local path across network element 10 extends from a single input port of the first set of input ports or from a single channel of an input port of the second set of input ports to an output port from the first set of output ports. For example, a signal that was received at input port 200 having a first wavelength out eighty predefined wavelengths and destined to OUTPUT PORT_10 410 is: (a) sent via demultiplexer 2 296 to first channel 201 of input port 200, first channel 201 starts at O/E converter 101a and ends at tunable laser 201h, (b) transmitted as an intermediate optical signal having a tenth wavelength to switch 291a, optical combiners 292a and 193 to output demultiplexer 194, (c) sent to OUTPUT PORT_10 410, (d) transmitted from OUTPUT PORT_10 410 to a destination residing outside the network.

A group of eighty local paths, each local path characterized by a wavelength out of the eighty predefined wavelengths, extend from a single input port of the first set of input ports or from a single channel of an input port of the second set of input ports to each output port of output ports 295 and 395. According to one embodiment of the invention, a signal destined to output port 295 can be converted to an intermediate optical signal that has a wavelength selected from the eighty predefined wavelengths.

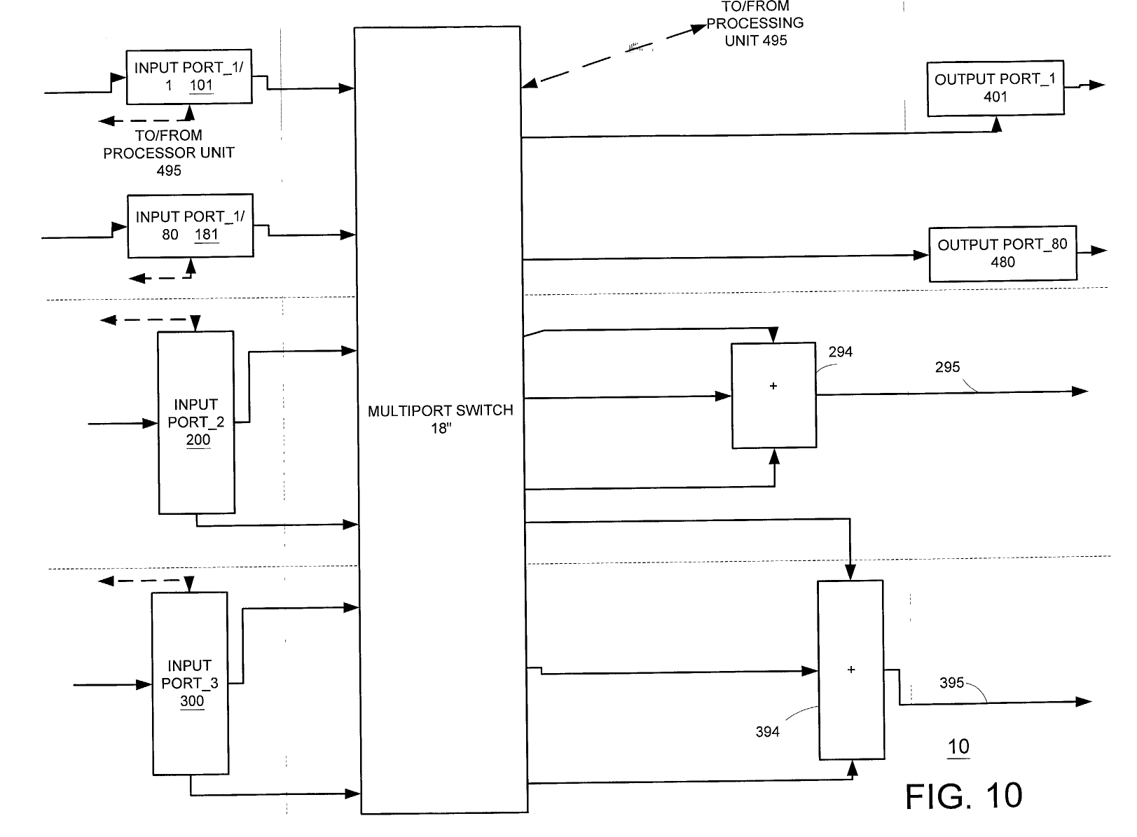

FIG. 10 is a schematic diagram illustrating a portion of an optical network element 10 of the WDM network, according to another preferred embodiment of the invention. The portion of FIG. 10 is analogues to the portion of FIG. 2 but interconnection unit 490 of FIG. 10 has a multiport switch 18″ instead of spatial switches SWITCH_1/1-SWITCH_1/80 191a-191z, SWITCH_2/1-SWITCH_2/80 291a-291z and SWITCH_3/1-SWITCH_3/80 391-391z, optical combiners 192a-192c, optical combiners 292a-292c, optical combiners 392a-392c, optical combiners 193 and output demultiplexer 194. Multiport switch 18″ is controlled by processing unit 495 and is configured to accommodate a plurality of paths between its input and output ports.

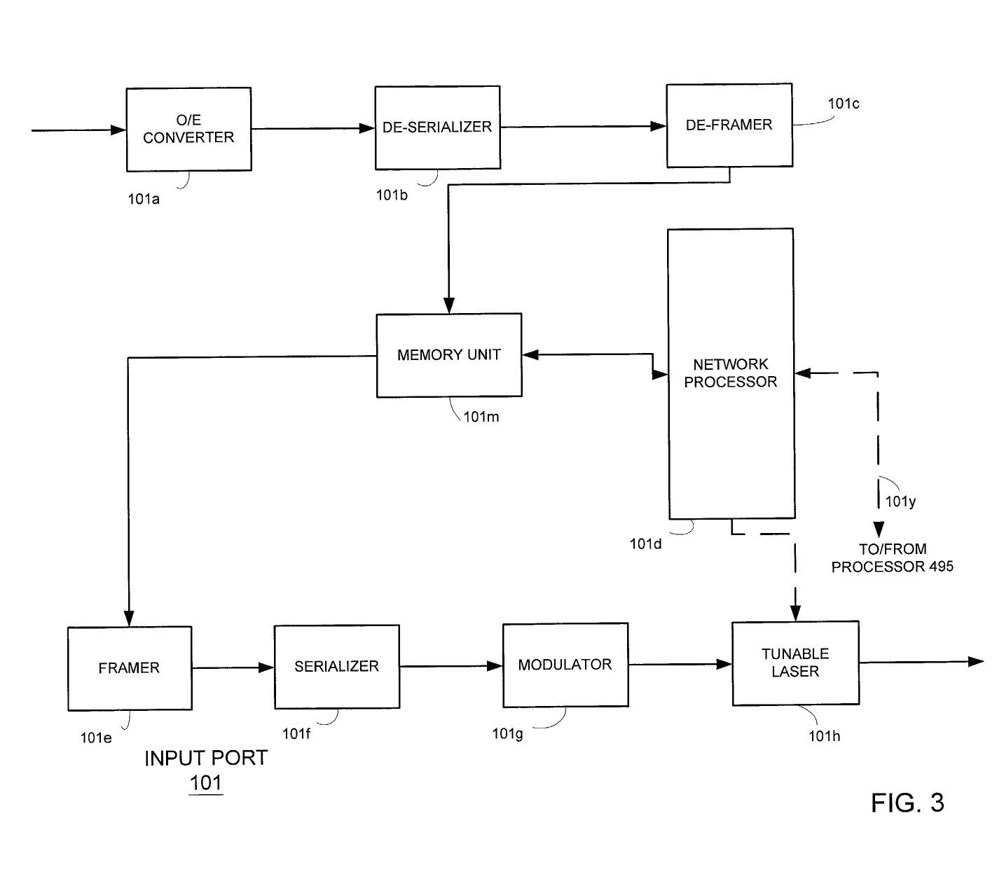

Referring to FIG. 3 illustrating INPUT PORT_1 101. INPUT PORT_1 101 includes an optical to electrical (O/E) converter 101a, de-serializer 101b, de-framer 101c, memory unit 101m, network processor 101d, framer 101e, serializer 101f, modulator 101g and tunable laser 101h. O/E converter 101a is configured to receive a 10 Gbs SONET frame and to convert it to an input electrical signal and provide the input electrical signal to de-serializer 101b that performs a serial to parallel conversion of the input electrical signal to a provide a plurality of lower bit rate signals. The lower bit rate signals can be handled by logic circuits within de-framer 101c and especially in network processor 101d. De-framer 101c strips the SONET header and provides the SONET payload to memory unit 101m, the memory unit 101m being accessible to network processor 101d and is managed by network processor 101d. Network processor 101d either receives an indication that SONET payload was provided to memory unit 101m or otherwise scans the content of memory unit 101m and retrieves a portion of the SONET payload to be processed to determine to which output port to provide each data packet of the SONET payload. Usually, a SONET payload includes a plurality of data packets, each data packet has a header and a data payload. Each data packet is handled separately by network processor 101d. Network processor 101d analyses the data packet header to determine a selected local path across network element 10 and additional information such as the data packet flow. Network processor 101d manages a plurality of queues within memory unit 101m. A queue can be maintained for each output port out of output ports 401-480, 295 and 395, but additional queues can be maintained to guarantee quality of service demands, to support priorities, to enhance the fairness of handling data packet flows, for eliminating HOL blocking, and for allowing and enhancing multicast and broadcast capabilities. According to one preferred embodiment of the invention at least one queue is maintained for each local path.

When at least a portion of the content of a queue can be sent across intermediate unit 490, the content is provided to framer 101e, that attaches a label to each data packet of the content. The queue can store a single data packet or a burst of data packets that are destined to be sent across a single local path. The label reflects the selected local path. Framer 101e receives and provides a plurality of lower bit rate information streams, the plurality of lower bit information streams are converted to a single high bit rate information stream by serializer 201. The single high bit rate information stream is sent to modulator 101g and is used to modulate tunable laser 101h. As illustrated by a dashed arrow pointing to tunable laser 101h, network processor 101d controls the wavelength of the intermediate optical signal that is sent from tunable laser 101h to SWITCH_1/1 191a.

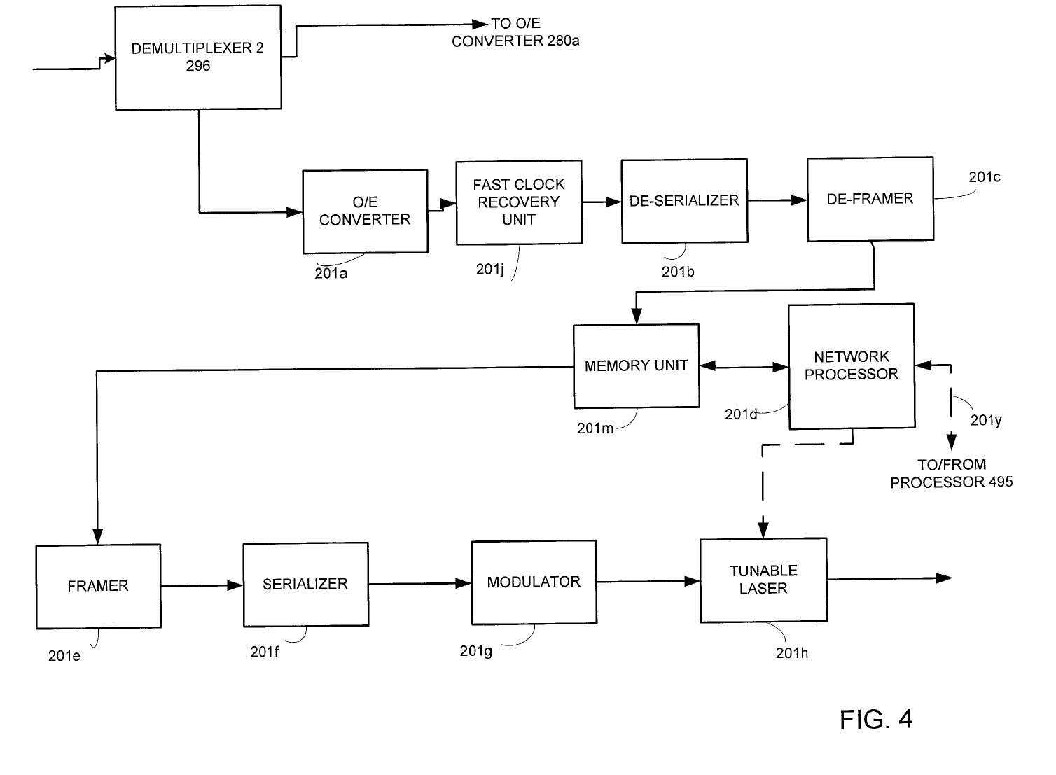

Referring to FIG. 4 illustrating a portion out of INPUT PORT 200. The portion includes demultiplexer_2 296 and a first channel 201 out of eighty channels of input port 200. First channel 201 is analogues to INPUT PORT_1 101 but has a fast clock recovery unit 201j, for performing clock recovery of data packets having a first wavelengths received by input port 200.

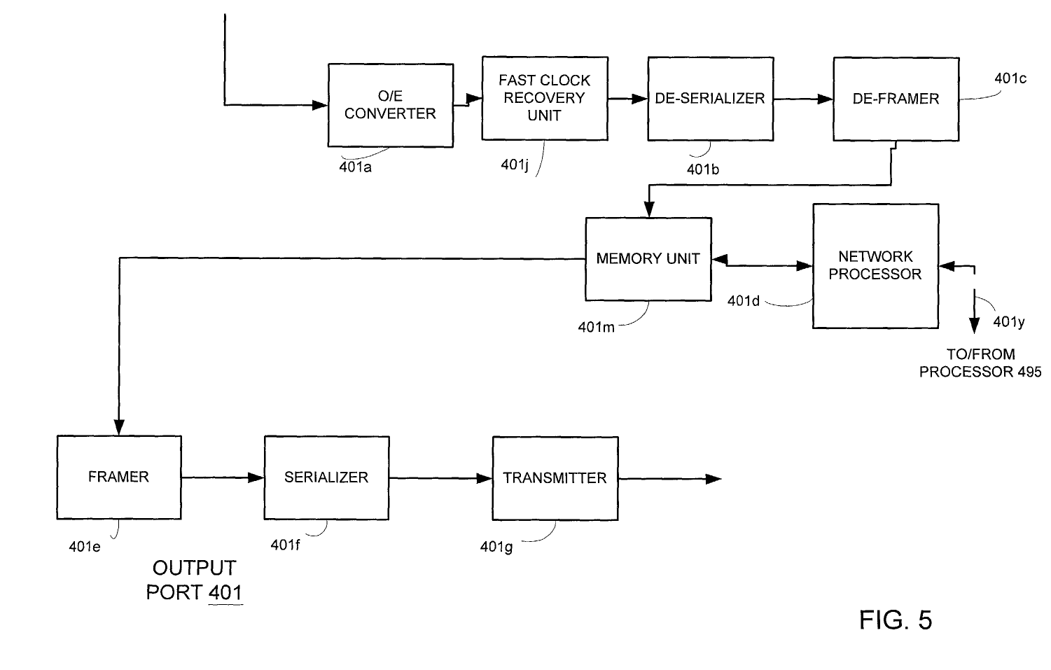

Referring to FIG. 5 illustrating OUTPUT PORT_1 401. OUTPUT PORT_1 401 includes O/E converter 401a, fast clock recovery unit 401j, de-serializer 401b, de-framer 401c, memory unit 401m, network processor 401d, framer 401e, serializer 401f and transmitter 401g.

O/E converter 401a receives an intermediate optical signal being representative of at least one data packet and converts it to an electrical signal. The electrical signal is provided to fast clock recovery unit 201j for reshaping and retiming of the electrical signal and provides the reshaped and retimed signal to de-serializer 201b. De-serializer 201b converts the very high bit rate electrical signal to a plurality of lower bit rate information signals. These lower bit signals are provided to de-framer 201c for stripping the label and for providing memory unit 201m data packets. The data packets are either sent directly to framer 201e or queued to provide a burst of data packets. Framer 201e adds a SONET header to the data packets to generate low bit rate SONET frames. The low bit rate SONET frames are converted to a 10 Gbs SONET frames by serializer 401f to be sent by transmitter 401g to a destination that resides out of the network.

According to a preferred embodiment of the invention a set optical paths across network 1 are established by either a centralized management entity of by the various network elements. Network elements 10-24 of network 1 can establish optical paths by exchanging routing information using routing protocols such as IS-IS. Each optical path includes a plurality of network elements interconnected by optical links. Each network element along the optical path is represented by a pair of a selected input port and output port.

A pair of an input port of the first set of input ports and an output port of a network node can be interconnected by a group of local paths. A pair of a channel of an input port of the second set of input ports and an output port of a network node can be interconnected by a group of local paths. For example, input port 101 is coupled to output port 295 by eighty local paths. Each of eighty channels of input port 200 is coupled to output port 295 by a group of eighty local paths. Usually, the routing protocols do not handle the selection of local paths out of each group. The allocation of local paths of a group of local paths and local paths load balancing are done locally, by each network element.

According to yet another embodiment of the invention network processors such as network processor 101d, monitor the load on each local path of a group of eighty local paths that start at their input port and end at output port 295. The network processor further monitor the load on each local optical path of another group of eighty local paths that start at their input port and end at output port 395. Referring to FIG. 2, each local path is characterized by a wavelength out of eighty wavelengths and a location of spatial switches, such as SWITCH_1/1 191a. Each network processor is configured to balance the load between members of each group of local paths. Conveniently, each network processor performs the load balancing without causing a disorder of data packets that belong to the same flow. The disorder is prevented by providing data packets that have the same flow class indication to the same local path. The load is balanced by applying a hashing function to generate the flow class indications. The flow class indications are mapped to the local optical paths such that data packets having the same flow class indications are provided to the same local path.

When a data packet arrives at an input port out of INPUT PORT_1 101-INPUT PORT_80 180 the flow indication is generated by applying a hash function on some of the following fields within the header of each data packet: destination address, source address, protocol type, destination application, source application.

When a data packet arrives at an input port out of input port 200 and input 300 the flow class indication is generated by applying a hashing function on a flow indication field and the label of the data packet. The flow indication field is used to improve the distribution between the local optical paths, as the distribution quality of hashing functions is usually improved when applied on larger fields. Labels usually include forwarding information for selecting an output port out of eighty two output ports (for example, output ports 401-480, 295 and 395) and accordingly the application of hashing function on the label itself does not provide an adequate quality of distribution between the local routes. A flow indication represents the flow, and not the flow class of the data packet, thus providing additional information about the data packet. A flow indication can be calculated by processing at least some of the IP header fields of the data packet. According to another preferred embodiment of the invention, a label is not attached to the data packet and the selection of the output port and/or the local path are based upon the content of at least the data packet itself.

Each network processor is further configured to change either the hashing function or the mapping between the flow indications and local optical paths if at least one of the following condition if fulfilled: (a) the packet traffic load is not substantially evenly distributed between the local optical paths, (b) the load on only a portion of the local optical paths exceeds a predefined load threshold, or (c) data packets are queued at memory units for a period that exceeds a predefined time period before being sent to the local optical paths.

The change of the mapping or the hashing function can cause temporarily disorders. In order to prevent these disorders, such a change can be preceded by a step of stopping the generation of the flow indication for a predefined period or by waiting until a next hop network element does not store any data packets from the flow.

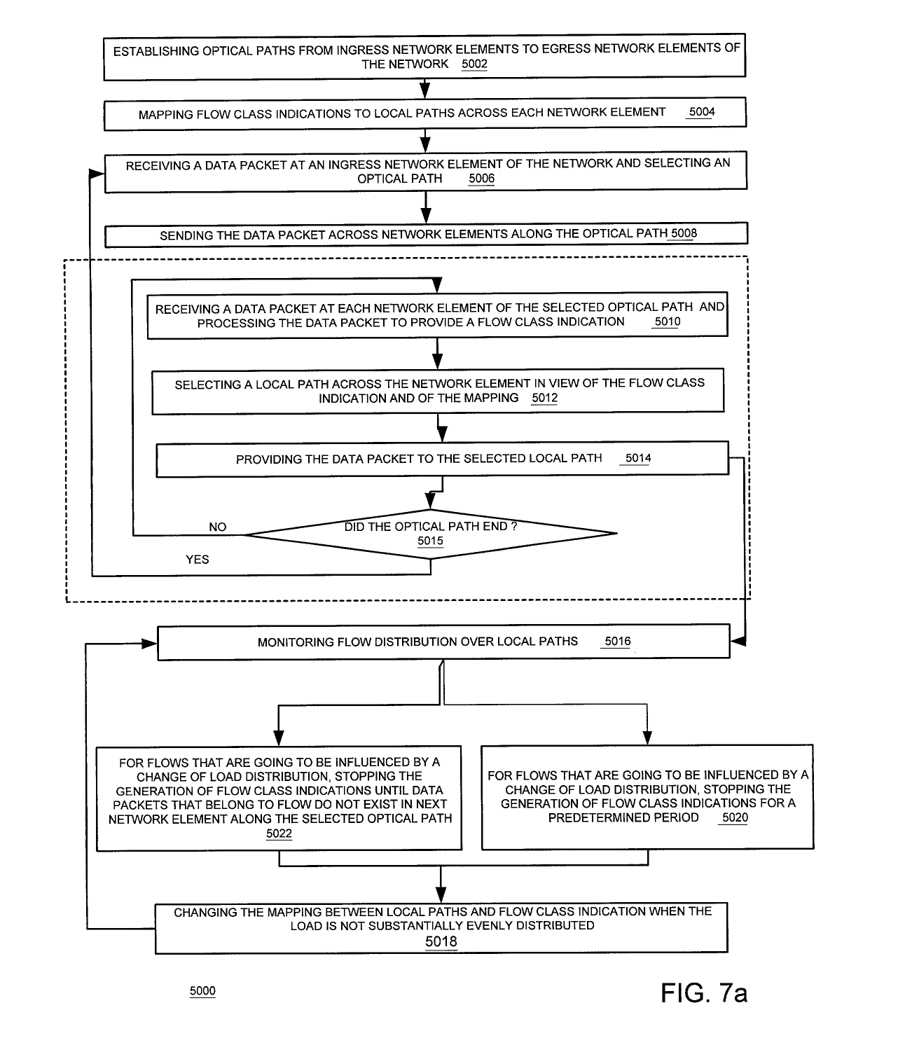

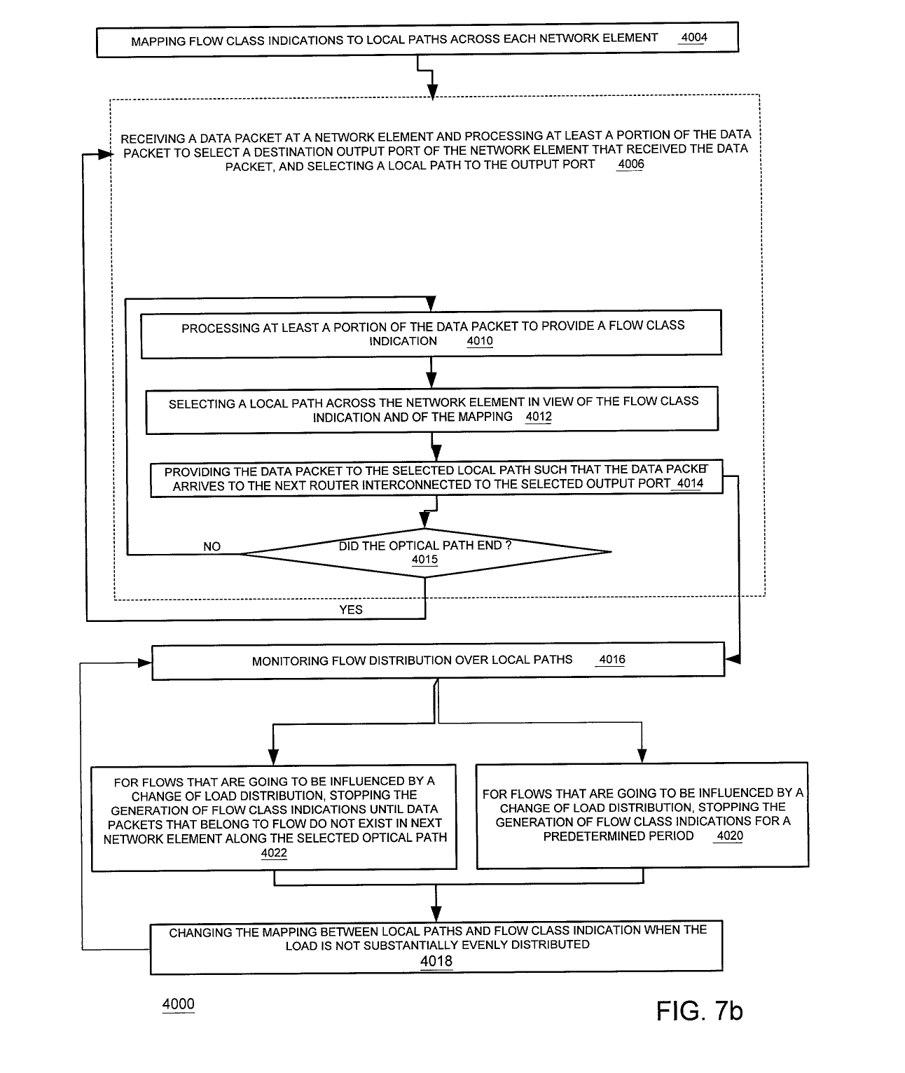

Referring to FIG. 7a there is illustrated method 5000 for preventing a disorder of a sequence of data packets traversing a network.

Method 5000 starts at step 5002 of establishing optical paths. Each optical path is characterized by a set of selected input ports and output ports of network elements. A group of local paths across each network element connect the elements of each pair of selected input port and selected output port.

Step 5002 is followed by step 5004 of mapping flow class indications to local paths across each network element. A flow class indication being representative of a class of flows to which the data packet belongs. Conveniently, the flow class indication is responsive to at least one parameter selected from the group consisting of: data packet destination address; data packet source address; data packet protocol type; data packet destination application, data packet source application and flow class indication field. According to one aspect of the invention a local look-up table is generated and stored at each network element. The look-up reflects said mapping.

Step 5004 is followed by a sequence of steps 5006-5016 that are repeated for each received data packet.

The sequence starts at step 5006 of receiving a data packet at an ingress edge network element and selecting an optical path across the network. Usually, a label being indicative of the selected optical path is attached to the data packet. The label can remain the same through the selected optical path and can also be swapped at each network element, using label swapping schemes such as but not limited to MPLS.

Step 5006 is followed by step 5008 of sending the data packet across the optical path. Step 5008 includes steps 5010-5015 that are performed at each network element across the selected optical path. Method 5000 further includes optional steps 5016-5018.

Step 5010 of receiving a data packet and processing a portion of the data packet to provide a flow class indication. Conveniently, the step of processing the data packet to provide a flow class indication includes a step of applying a hashing function on the at least portion of the packet. The hashing function provides a hash value is used to perform a look-up at the local look-up table within the network element.

Step 5012 of selecting a selected local path across the network element in view of the flow class indication and the mapping between the flow class indication and the local paths across the network element.

Step 5014 of providing the data packet to the selected local path.

Step 5014 is followed by query step 5015 for determining whether the network element is the last network element of the optical path. If the answer is “yes”, meaning that the network element is an egress network element then step 5008 ends, the data packet is provided to a router of an IP network interconnected to the egress network element and step 5015 is followed by step 5006.

If the answer if “no”, meaning that the network element if followed by another network element along the optical path then step 5015 is followed by step 5010.

Conveniently, step 5014 is followed by step 5016 of monitoring flows propagating over each local path. After a data packet is provided to a selected local path the network processor that was responsible to the path selection updates a local path load indication that reflects the load on the selected local path to determine the load on the selected local path.

Step 5016 is followed by step 5018 of changing the either the mapping between the flow class indications and the local paths or changing the distribution function that is used to generate the flow class indication. The change is made to balance the load among the local paths. The change can be initiated when a predefined load balancing criteria is fulfilled. For example, when the load is not substantially balanced among the local paths, when some paths are very busy while others are almost not occupied, when the packet traffic load is not substantially evenly distributed between the local paths, when the load on only a portion of the local path exceeds a predefined load threshold, or when data packets are queued for a period that exceeds a predefined time period before being sent to the local path. Step 5018 is not executed whenever a data packet is received but is usually executed whenever a much longer predefined period expires. Step 5018 can also be initiated in view of predefined load balancing criteria. Conveniently, step 5018 is preceded by either one of steps 5020 and 5022 that prevents dir-order of data packets resulting from the change of mapping of distribution function during a transmission of data packet belonging to a single flow. Step 5020 of stopping the generation of the flow class indication and preventing data packets to be sent to the selected local path for a predefined period. Step 5022 of stopping the generation of the flow class indication and preventing data packets to be sent to the selected local path until data packets of flows to be affected by the changing of the mapping are transmitted from the next network element along the selected optical path.

Referring to FIG. 7b there is illustrated method 4000 for preventing a disorder of a sequence of data packets traversing a network.

Method 4000 starts at step 4004 of mapping flow class indications to local paths across each network element. A flow class indication being representative of a class of flows to which the data packet belongs. Conveniently, the flow class indication is responsive to at least one parameter selected from the group consisting of: data packet destination address; data packet source address; data packet protocol type; data packet destination application, data packet source application, and flow indication field. According to one aspect of the invention a local look-up table is generated and stored at each network element. The look-up reflects said mapping.

Step 4004 is followed by a sequence of steps 4006-4016 that are repeated for each received data packet.

The sequence starts at step 4006 of receiving a data packet at an network element and processing at least a portion of the data packet and/or a label attached to the data packet to select a destination output port of the network element that received the data packet and to select the local path to the destination network element. Usually, a label being indicative of the selected optical path is attached to the data packet at a network element acting as an ingress network element. The label can remain the same through the selected optical path and can also be swapped at each network element, using label swapping schemes such as but not limited to MPLS.

Step 4006 includes steps 4010-4015 that are performed at each network element that receives the data packet. Method 4000 further includes optional steps 4016-4018.

Step 4010 of processing a portion of the data packet to provide a flow class indication. Conveniently, the step of processing the data packet to provide a flow class indication includes a step of applying a hashing function on the at least portion of the packet. The hashing function provides a hash value is used to perform a look-up at the local look-up table within the network element.

Step 4012 of selecting a selected local path across the network element in view of the flow class indication and the mapping between the flow class indication and the local paths across the network element.

Step 4014 of providing the data packet to the selected local path.

Step 4014 is followed by query step 4015 for determining whether the network element coupled to the destination network element is an engress network element. If the answer is “yes” then step 4008 ends, the data packet is provided to a router of an external network interconnected to the egress network element and step 4015 is followed by step 4006.

If the answer if “no”, meaning that the network element is not an egress network element then step 4015 is followed by step 4010.

Step 4006 is followed by step 4008 of sending the data packet to the destination output port to the network element coupled to the destination output port. Method 4000 further includes optional steps 4016-4018.

Conveniently, step 4014 is followed by step 4016 of monitoring flows propagating over each local path. After a data packet is provided to a selected local path the network processor that was responsible to the path selection updates a local path load indication that reflects the load on the selected local path to determine the load on the selected local path.

Step 4016 is followed by step 4018 of changing the either the mapping between the flow class indications and the local paths or changing the distribution function that is used to generate the flow class indication. The change is made to balance the load among the local paths. The change can be initiated when a predefined load balancing criteria is fulfilled. For example, when the load is not substantially balanced among the local paths, when some paths are very busy while others are almost not occupied, when the packet traffic load is not substantially evenly distributed between the local paths, when the load on only a portion of the local path exceeds a predefined load threshold, or when data packets are queued for a period that exceeds a predefined time period before being sent to the local path. Step 4018 is not executed whenever a data packet is received but is usually executed whenever a much longer predefined period expires. Step 4018 can also be initiated in view of predefined load balancing criteria. Conveniently, step 4018 is preceded by either one of steps 4020 and 4022 that prevents dir-order of data packets resulting from the change of mapping of distribution function during a transmission of data packet belonging to a single flow. Step 4020 of stopping the generation of the flow class indication and preventing data packets to be sent to the selected local path for a predefined period. Step 4022 of stopping the generation of the flow class indication and preventing data packets to be sent to the selected local path until data packets of flows to be affected by the changing of the mapping are transmitted from the network element coupled to the selected output port of the network element.

According to another aspect of the invention, data packet bursts are sent across the network element. The transmission of data packet bursts allows to reduce the number/rate of forwarding decisions, reduces the data packet overhead as a label is required for a burst and not for every data packet. The transmission of data packet bursts allows to cheaper and more available wavelength converters, and/or configurable switches, spatial switches. For example, assume that the transmission of a data packet requires a wavelength conversion and the settling time of a tunable laser is much longer than the length of the data packet. Data packet bursts each having a length corresponding to the settling period can be efficiently transmitted by two interleaved lasers.

Conveniently, at least one queue is maintained at each input port of the first set of input ports or at each channel of the second set of input ports for each local path starting from the input port/channel. Queues can be allocated to support quality of service demands. The number of queues at each input port/channel is directly proportional to the number of local paths accessible by the input port/channel and the number of queues maintained for each local path. The queues are managed by a network processor in various manners, such as but not limited to the method described at U.S. patent application titled “Multiport switch and a method for forwarding variable length packets across a multiport switch”, filed Dec. 18, 2000, that is hereby incorporated by reference in its entirety.

The distribution of traffic among a large number of queues increases the time required to fill a queue and accordingly increases the network element delay. In order to reduce the delay, the number of accessible local paths and accordingly the number of queues maintained within each input port/channel is limited. The number can be adapted to the load on the accessible local paths, so that the number of accessible local paths increases when the members of the sub group are busy, and vice verse. As the network element supports load balancing schemes, the load has to be balanced between members of each sub group. Accordingly, when the sub group is changes, a distribution function that performs the local balancing is changed.

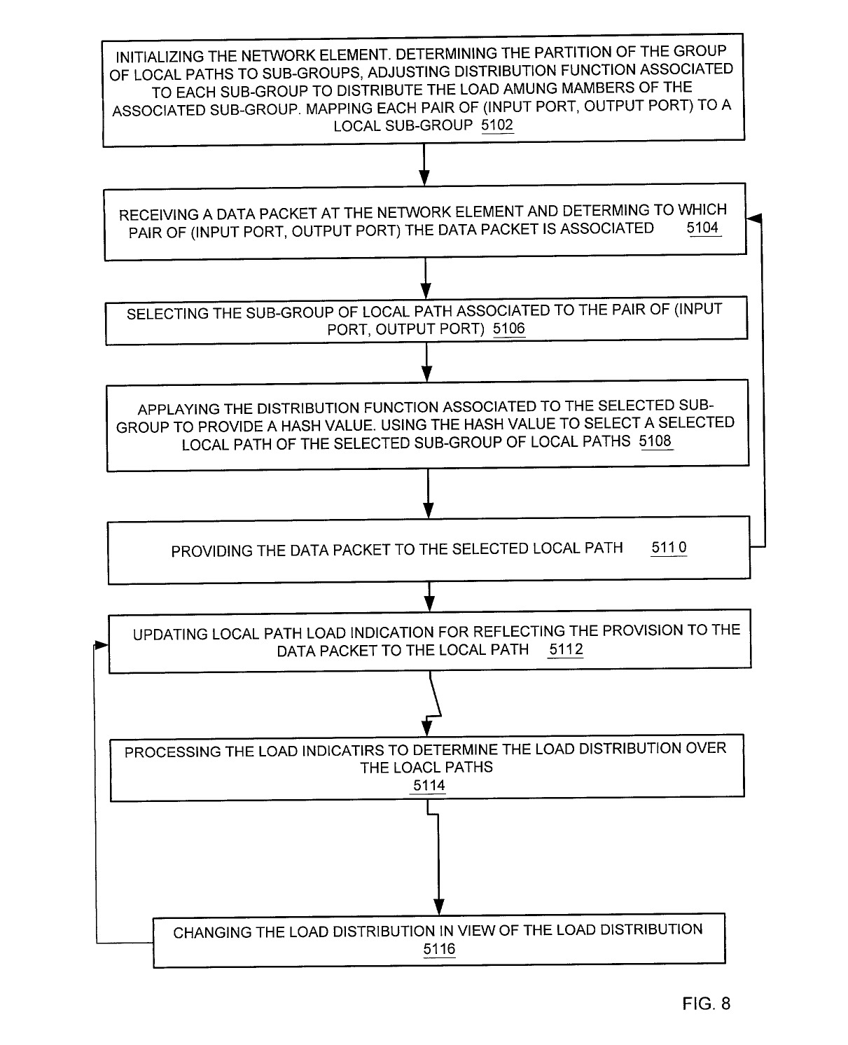

Referring to FIG. 8 illustrating a method 5100 for local path determination, according to a preferred embodiment of the invention.

Method 5100 starts at step 5102 of initialization. During step 5100 the size of each sub-group of local paths and accordingly the queue allocation is determined. Step 5102 also includes a step of mapping local sub-groups to (channel, output ports) if the input port is of the second set of input ports or to (input port, output port) if the input port is of the first set. Referring to the example set forth at FIG. 2, the load between local paths starting at an input port of the first set of input ports (or each channel of the input port of the second set of input ports) and ending at output port 295 can be balanced between eighty wavelengths. Preferably, each sub-group of wavelengths includes a plurality of consecutive wavelengths starting at a base wavelength. The distribution function is a CRC function that is masked by programmable mask that determined the size of each sub-group. During step 5101 the programmable mask is set up.

Step 5102 is followed by step 5104 of receiving a data packet at an input port and determining to which output port the data packet is destined. Referring to the example set forth at FIG. 2, it is assumed that the data packet arrives to an input port 510 of network element 12 and has to propagate over a local path across network element 12 to be outputted by output port 695.

Step 5104 is followed by step 5106 of selecting a sub-group of paths that is associated with the pair of input port output port. Referring to the example set forth at FIG. 2, it is assumed that the pair (510, 695) is associated with the tenth sub-group of local paths across network element 12. The tenth sub-group starts at the 20'th wavelength and ends at the 27'th wavelength of network element 12.

Step 5106 is followed by step 5108 of applying the distribution function on some fields of the data packet to provide a hash value and using the hash value to determine the local path across the network element. For example, applying the CRC function on some portions of the data packet to provide a 16-bit hash value. The hash value is masked to provide a three bit offset. The offset if added to the base wavelength to determine the wavelength/local path of the data packet. Assuming that the offset is 5 then the 25'th local path is selected.

Step 5108 is followed by step 5110 of providing the data packet to the selected local path.

Step 5110 is followed by steps 5104 and 5112. Step 5112 starts a sequence of steps for monitoring the load on the local paths and in necessary changing the load balancing scheme.

During step 5112 a load indicator is updated to reflect the provision of the data packet to the selected path.

Step 5112 is followed by step 5114 of processing the load indicators to determine the load on various local paths of the network element. Step 5114 is usually executed either at each predefined period or when the load on some local paths exceeds a predefined threshold.

Step 5114 is followed by step 5116 changing the load-balancing scheme. This change can be implemented by changing the size of a sub-group, changing the allocation of wavelengths to sub-groups. For example, the configurable mask can be configured to allow more or less members within a sun-group. The base wavelength can be altered. The distribution function can be changed. Assuming that the wavelengths/local paths of the tenth sub-group of wavelengths are very busy, the size of the tenth sub-group can be extended to sixteen members by programming the mask of the tenth sub-group to provide four bits of the hash value. The base wavelength can also be changed from the 20'th wavelength to the 30'th wavelength. Conveniently, step 5116 is preceded by either one of steps 5120 and 5122 that prevent dir-order of data packets resulting from the change of mapping of distribution function during a transmission of data packet belonging to a single flow. Step 5120 of stopping the generation of the flow class indication and preventing data packets to be sent to the selected local path for a predefined period. Step 5122 of stopping the generation of the flow class indication and preventing data packets to be sent to the selected local path until data packets of flows to be affected by the changing of the mapping are transmitted from the next network element along the selected optical path or from the next network element coupled to the selected output port.

According to another aspect of the invention, some of the optical paths across network 1 are packet switched paths and some of the optical paths are circuit switched paths. The circuit switched paths can support much more traffic than the packet switched paths, while the packet switched paths offer higher bandwidth utilization. Conveniently, data packets that traverse a packet switched path have a label being indicative the packet switched paths, data packets that traverse a circuit switched path have a wavelength that is indicative of the circuit switched path.

At each network element of network 1, some wavelengths/local paths can be allocated for packet switched paths and some wavelengths/local paths can be allocated for circuit switched path. Some local paths/wavelengths can be dynamically configured to accommodate either packet switched paths or circuit switched paths.

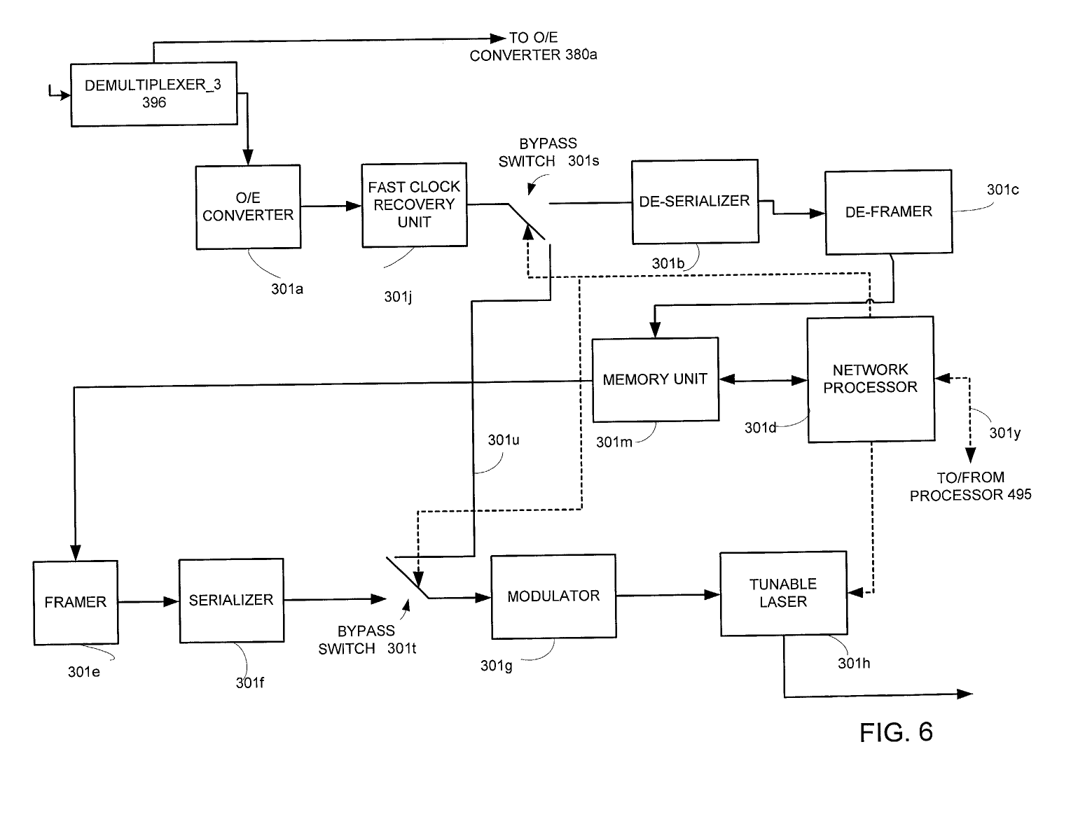

FIG. 6 illustrates a first portion of INPUT PORT_3 300 that is configured to accommodate both types of paths. This portion includes demultiplexer_3 396 and second channel 302 out of eighty channels of INPUT PORT_3 300. The second channel is analogues to first channel 201 but has a bypass path 301u and two bypass switched 301s and 301t for allowing data packets to bypass packet processing units such as de-serialized 301b, de-framer 301c, network processor 301d, memory unit 301m, framer 301e and serializer 301f. According to another preferred embodiment of the invention, data packets traversing circuit switched paths do not undergo O/E and E/O conversion at each network element. Accordingly, a bypath path is established between demultiplexer 396 and tunable laser 301h.

According to another aspect of the invention at least one optical path includes a packet switched path and at least one optical path includes a circuit switched path. An optical path can include both a circuit switched path and an packet switched path. The distribution of data packet among the optical paths is based upon at least one of the following parameters: (i) the data packet flow; (ii) the ingress network element that received the data packet; (iii) the destination of the data packet; (iv) at least one predefined criterion. Usually, the selection of a selected optical path is preceded by a step of monitoring the propagation of data packets flows across the optical paths and determining whether the data packet flow fulfilled a predefined criterion. The selection is based upon the determination.

A predefine criterion can relate to the data packet flow, to the optical path, or to predefined user or system administrator policies, such as traffic engineering or traffic policing. For example, a predefined criterion can be related to the data packet flow bandwidth, data packet flow volume, data packet flow delay sensitivity, data packet flow priority; data packet flow source, and data packet source destination, an optical path available bandwidth, an optical path delay, an optical path length, an optical path cost; and an optical path jitter.

Conveniently, if the selected optical path has a packet switched path, the provision of the data packet to the selected optical path further involves the generation of a label being indicative of the packet switched path, at the beginning of the optical switched path of the selected optical path; the attachment of the label to the data packet, the processing of the label at each network element along the packet switched path and forwarding the label and the data packet accordingly. If the selected optical path has a circuit switched path, the provision of the data packet involves changing the wavelength of the data packet to a predefined wavelength associated with the circuit switched path, at the beginning of the circuit switched path; and at each network element along the circuit switched path detecting the wavelength of the data packet and forwarding the data packet accordingly.

Only for convenience of explanation it is assumed that the predefined criteria relates to the volume of the data packet flow, and that data packet flows that exceed a predefined volume threshold are provided to circuit switched paths.

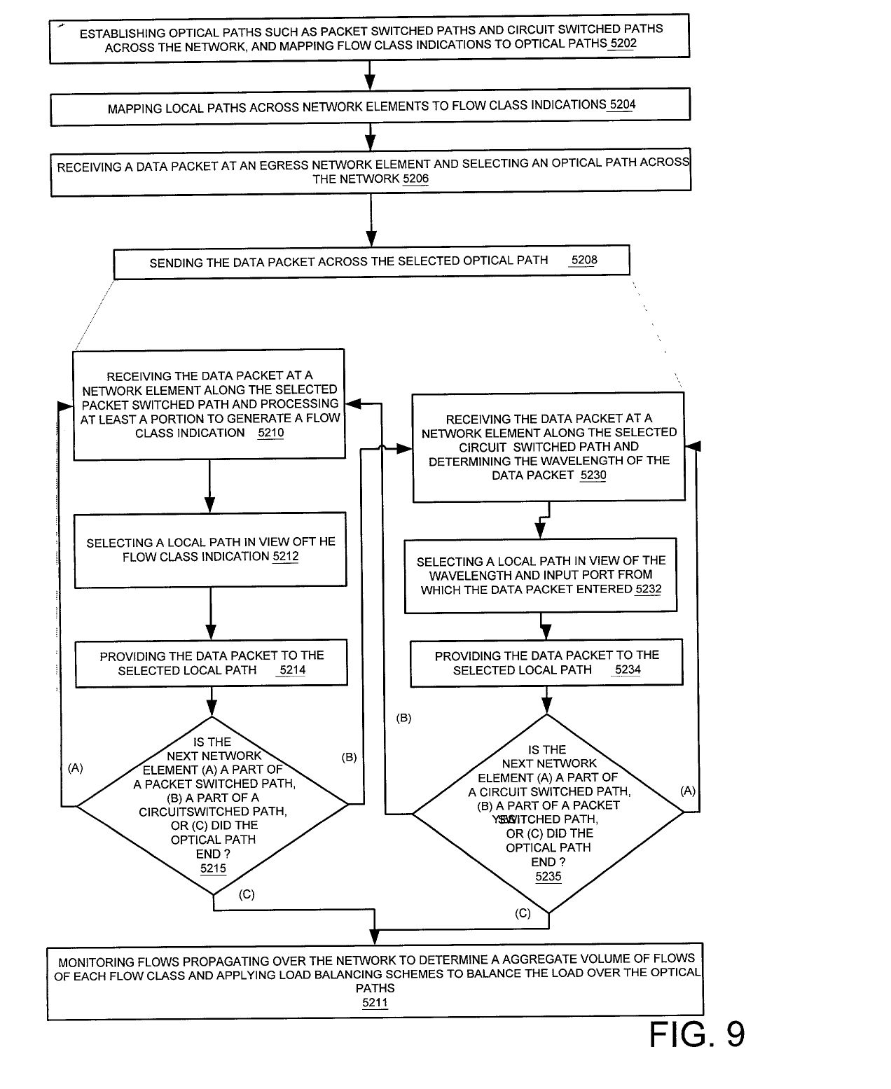

FIG. 9 illustrates method 5200 for propagating data packet flows over network 1, according to a preferred embodiment of the invention. Method 5200 starts at step 5202 of establishing optical path across a network. An optical path can include packet switched paths and/or circuit switched paths. Accordingly, an optical path can start as a packet switched path and turn into a circuit switched path and vice verse. Referring to the example set forth at previous figures, optical paths are established by centralized or distributed management schemes. Usually, at each network element some local paths can support only packet switched routing while other local paths can support only circuit switched routing. Local paths that can support both types of routing are configured to support one type of routing. For example, at INPUT PORT_3 300 the first ten channels 301-310 can support both types of routing, while the following 30 channels 311-340 support only packet switched routing. Channels 341-380 support only circuit switched routing. When system 1 is initialized, each of the first ten channels is configured to support a type of routing by controlling the bypass switches. At circuit switched channels the wavelength of the tunable lasers are also determined. Assuming that the first channel 301 is configured to support circuit switched routing then network processor 301d controls bypass switches 301s and 301t to coupled both to bypass path 301u. Network processor 301u also has to configure tunable laser to output signals having a predefined wavelength.

Network elements of network 1 exchange routing information to determine the labels associated with packed switched paths and the wavelengths associated with circuit switched paths. Conveniently, network 1 supports label switching schemes, such as but not limited to MPLS. Network 1 also supports MPλS. At each network element along a circuit switched paths the wavelength of an incoming data packet determines the local path across the network element, the output port of the network element and the wavelength of the data packet transmitted from the network element. The wavelength of a data packet can remain constant through the circuit switched path, but it is not necessary.

At each network element along a packet switched paths the label associated with an incoming data packet determines the local path across the network element, the output port of the network element and the wavelength of the data packet transmitted from the network element. The label associated with the data packet can remain constant through the packet switched path, but usually the label is swapped at each network element.

According to another embodiment of the invention, destination information that allows to determine the destination of a data packet is encapsulated within the data packet and is not within a label attached to the data packet.

Step 5202 also includes a step of mapping optical paths to flow class indications. Data packets arriving to network 1 are provided to paths according to the flow classes to which they belong. The flow class is reflected by a set of parameters within each incoming data packet. When an ingress flow receives a data packet it determined the flow class to which the packet belongs and sends it to an optical path that is associated with that flow class.

Step 5202 is followed by step 5204 of mapping flow class indications to local paths across each network element. A flow class indication being representative of a class of flows to which the data packet belongs. Conveniently, the flow class indication is responsive to at least one parameter selected from the group consisting of: data packet destination address; data packet source address; data packet protocol type; destination application, source application and flow class indication field. According to one aspect of the invention a local look-up table is generated and stored at each network element. The look-up reflects said mapping.

Step 5204 is followed by a sequence of steps 5206-5216 that are repeated for each received data packet.

The sequence starts at step 5206 of receiving a data packet at an ingress edge network element and selecting an optical path across the network. The optical path can be a packet switched path or a circuit switched path. The selection is based upon the flow of the data packet. A circuit switched path is used to propagate flows of a very large volume. Conveniently, each circuit switched path is associated with a wavelength, so that the data packet destined to a certain optical path is optically transmitted from the ingress network element having a wavelength that is associated with the selected optical path. The wavelength can remain constant through the optical pass but can also be altered. Conveniently, a label being indicative of the selected optical path is attached to data packets destined to packet switched paths. The label can remain the same through the selected optical path and can also be swapped at each network element, using label swapping schemes such as but not limited to MPLS.

Step 5206 is followed by step 5208 of sending the data packet across the optical path. For packet switched paths, step 5208 includes steps 5210-5215 that are performed at each network element across the selected optical path. For circuit switched paths, step 5208 includes steps 5230-5235.

Step 5230 of receiving a data packet and determining its wavelength. The determination is usually based upon the input channel to which the data packet is provided.

Step 5230 is followed by step 5232 of selecting a selected local path across the network element in view of the data packet wavelength and the input port that received the data packet arrived.

Step 5232 is followed by step 5234 of providing the data packet to the selected local path.

Step 5234 is followed by query step 5235 for determining whether the next network element is a part of the circuit switched path, whether the next network element is a part of a packet switched path or whether the optical network ends. If the optical path ended then step 5208 ends, and the data packet is provided to a router of an external network interconnected to the network and step 5235 is followed by step 5206. If the next network element is a part of the circuit switched path then step 5235 is followed by step 5230. If the next network element is a part of a packet switched path then step 5235 is followed by step 5210.

For packet switched paths, step 5208 includes steps 5210-5215. Step 5210 of receiving a data packet and processing a portion of the data packet to provide a flow class indication. Conveniently, the step of processing the data packet to provide a flow class indication includes a step of applying a hashing function on the at least portion of the packet. The hashing function provides a hash value is used to perform a look-up at the local look-up table within the network element.

Step 5212 of selecting a selected local path across the network element in view of the flow class indication and the mapping between the flow class indication and the local paths across the network element.

Step 5214 of providing the data packet to the selected local path.

Step 5214 is followed by step 5215 for determining whether the next network element is a part of the packet switched path, whether the next network element is a part of a circuit switched path or whether the optical network ends. If the optical path ended then step 5208 ends, and the data packet is provided to a router of an external network interconnected to the network and step 5215 is followed by step 5206. If the next network element is a part of the circuit switched path then step 5215 is followed by step 5230. If the next network element is a part of the packet switched path then step 5215 is followed by step 5210.

Step 5208 is followed by step 5211 of monitoring flows propagating over the network to determine a volume of the flows classes and applying load balancing schemes to balance the load over optical paths. Conveniently, flow classes that exceed a volume threshold are mapped to circuit switched paths, while the other flow classes are mapped to packet switched paths. The load balancing scheme can also balance the load between packet switched paths to other packet switched paths, and between circuit switched paths to circuit switched paths. The load on each optical path is measured at the ingress network element. After the ingress network element provides the data packet to an optical path it updates an optical path load indication that reflects the load on the optical path and determined the volume of the flow. The optical load indication reflects the aggregate traffic through all possible local paths of the optical path. The local load balancing that is performed within each network element along an optical path is not taken into account. Conveniently, step 5211 includes a step of changing configurable channels that support packet switched routing to support circuit switched routing and vice verse, in view of the load on packet switched and circuit switched paths. For example, when network 1 has to handle larger volumes of data packet traffic, ingress network elements can initiate a process of increasing the number of circuit switched paths and decreasing the number of packet switched paths.

It will be apparent to those skilled in the art that the disclosed subject matter may be modified in numerous ways and may assume many embodiments other then the preferred form specifically set out and described above.

It will be apparent to those skilled in the art that the disclosed subject matter may be modified in numerous ways and may assume many embodiments other then the preferred form specifically set out and described above.

Accordingly, the above disclosed subject matter is to be considered illustrative and not restrictive, and to the maximum extent allowed by law, it is intended by the appended claims to cover all such modifications and other embodiments, which fall within the true spirit and scope of the present invention.

The scope of the invention is to be determined by the broadest permissible interpretation of the following claims and their equivalents rather then the foregoing detailed description.

We claim

1. A method for propagating data packet flows over a network, the network is configured to accommodate a plurality of optical paths between ingress network elements and egress network elements of the network, the method comprising the steps of:
establishing optical paths between ingress network elements and egress network elements, wherein at least one optical path comprising an packet switched path and at least one optical path comprising a circuit switched path;
receiving a data packet belonging to a data packet flow and providing the data packet to a selected optical path in view of at least one parameter selected from the group consisting of:
the data packet flow;
the ingress network element that received the data packet;
the destination of the data packet;
at least one predefined criterion.

2. The method of claim 1 further comprising:
monitoring the propagation of data packets flows across the optical paths;
determining whether the data packet flow fulfilled a predefined criterion; and providing data packet flows according to the determination.

3. The method of claim 1 wherein the at least one predefined criterion is selected from a group consisting of:
a predefined criterion related to the data packet flow;
a predefined criteria related to the optical path;
a predefined traffic engineering criterion; and
a predefined traffic policing criterion.

4. The method of claim 3 wherein the predefined criterion related to the data packet flow is related to at least one parameter selected from the group consisting of:
data packet flow bandwidth;
data packet flow volume;
data packet flow delay sensitivity;
data packet flow priority;
data packet flow source;
data packet source destination.

5. The method of claim 3 wherein the predefined criterion related to the optical path is related to at least one parameter selected from the group consisting of:
optical path available bandwidth;
optical path delay;
optical path length;
optical path cost; and
optical path jitter.

6. The method of claim 1 wherein the step of establishing circuit switched paths further comprises the step of allocating wavelengths to circuits switch paths.

7. The method of claim 1 wherein if the selected optical path has a packet switched path, the step of providing the data packet to the selected optical path further comprising:
generating a label being indicative of the packet switched path, at the beginning of the optical switched path of the selected optical path;
attaching the label to the data packet; and
at each network element along the packet switched path processing the label and forwarding the label and the data packet accordingly.

8. The method of claim 1 wherein if the selected optical path has a circuit switched path, the step of providing the data packet to the selected optical path further comprising:
changing the wavelength of the data packet to a predefined wavelength associated with the circuit switched path, at the beginning of the circuit switched path; and
at each network element along the circuit switched path detecting the wavelength of the data packet and forwarding the data packet accordingly.

9. The method of claim 1 further comprises a step of configuring configurable network elements to support either packet switched routing or support circuit switched routing in view of the load on optical paths across the network.

10. The method of claim 1 further comprises a step of balancing the load between optical paths.

11. The method of claim 1 wherein each packet switched path comprises of a plurality of local paths across network element along the packet switched path; and wherein the method further comprises a step of locally selecting, at each network element along the packet switched path, a local path across the network element.

12. The method of claim 11 further comprises a step of balancing the load among local paths across a network element along the selected packet switched path.

13. A method for propagating a data packet from a ingress network element to an egress network element in a wavelength division multiplexing (WDM) network, the method comprising the steps of:
establishing packet switched paths and optical channel trails between the ingress and the egress network elements, associating a label to each packet switched path and associating a wavelength to each optical channel trail;
initializing flow volume indications, each being indicative of the volume of a flow from ingress network elements to egress network elements;
receiving a data packet at the ingress network element;
analyzing the data packet to determine the to which path to provide the data packet; and
providing data packet of flows that exceed a predefined volume threshold to optical channel trails and providing flows that do not exceed the predefined threshold to packet switched paths.

14. The method of claim 13 further comprises a step of generating and storing at network elements a forwarding table for reflecting the association of labels to packet switched paths and for reflecting the association of wavelength to optical channel trails.

15. The method of claim 13 further comprises the steps of:
analyzing incoming data packets to determine to which optical channel trail to provide the data packet;
changing the wavelength of the data packet to a predefined wavelength associated to the optical channel trail; and
at each network element along the optical channel trail detecting the wavelength of the data packet and forwarding the data packet according to the wavelength of the data packet.

16. The method of claim 13 wherein the step of providing flows further comprises the steps of:
analyzing incoming data packets to determine to which packet switched path to provide the data packet;
generating a label being indicative of the packet switched path;
attaching the label to the data packet to provide a combined optical signal representative of the label and of the data packet; and
optically transmitting the combined optical signal across the packet switched path;
at each network element along the packet switched path detecting the label and forwarding the combined optical signal according to the content of the label.

17. The method of claim 16 further comprises a step of swapping labels at each network element along the packet switched path.

18. The method of claim 13 further comprises a step of configuring configurable network elements to support packet switched routing or support circuit switched routing in view of the load on optical paths across the network.

19. The method of claim 13 further comprises a step of balancing the load between optical path.

20. The method of claim 13 wherein each packet switched path comprises of a plurality of local paths across network element along the packet switched path; and wherein the method further comprises a step of locally selecting, at each network element along the packet switched path, a local path across the network element.

21. The method of claim 20 further comprises a step of balancing the load among local paths across a network element along the selected packet switched path.

22. A method for propagating a data packet from a ingress network element to an egress network element in a wavelength division multiplexing (WDM) network, the method comprising the steps of:
establishing packet switched paths and optical circuit switched paths between the ingress and the egress network elements, associating a label to each packet switched path and associating a wavelength to each packet switched path;
initializing flow volume indications, each being indicative of the volume of a flow from ingress network elements to egress network elements;
receiving a data packet at the ingress network element;
analyzing the data packet to determine the to which optical path to provide the data packet; and
providing data packet of flows that exceed a predefined volume threshold to circuit switched paths, providing flows that do not exceed the predefined threshold to packet switched paths.

23. The method of claim 22 further comprises a step of generating and storing at each network element a forwarding table for reflecting the association of labels to packet switched paths and for reflecting the association of wavelength to packet switched paths.

24. The method of claim 22 further comprises the steps of:
analyzing incoming data packets to determine to which circuit switched path to provide the data packet;
changing the wavelength of the data packet to a predefined wavelength associated to the circuit switched path; and
at each network element along the circuit switched path detecting the wavelength of the data packet and forwarding the data packet according to the wavelength of the data packet.

25. The method of claim 24 further comprises of a steps of converting the combined optical signal to a combined electrical signal and converting the combined electrical signal to a combined optical signal at each network element along the optical path.

26. The method of claim 22 wherein the step of providing flows further comprises the steps of:
analyzing incoming data packets to determine to which packet switched path to provide the data packet;
generating a label being indicative of the packet switched path;
attaching the label to the data packet to provide a combined optical signal representative of the label and of the data packet; and
optically transmitting the combined optical signal across the packet switched path;
at each network element along the packet switched path detecting the label and forwarding the combined optical signal according to the content of the label.

27. The method of claim 26 further comprises a step of swapping labels at each network element along the packet switched path.

28. The method of claim 22 further comprises a step of configuring configurable network elements to support packet switched routing or support circuit switched routing in view of the load on optical paths across the network.

29. The method of claim 22 further comprises a step of balancing the load between optical path.

30. The method of claim 22 wherein each packet switched path comprises of a plurality of local paths across network element along the packet switched path; and wherein the method further comprises a step of locally selecting, at each network element along the packet switched path, a local path across the network element.

31. The method of claim 30 further comprises a step of balancing the load among local paths across a network element along the selected packet switched path.

32. A network comprising a plurality of egress network elements, ingress network elements and intermediate network elements, the network elements are interconnected by a optical links, wherein the network is configured to accommodate optical paths from ingress network elements to egress network elements, the network comprising at least one network control entity configured to establish optical paths from ingress network elements to egress network elements; wherein at least one optical path includes a packet switched path and at least one optical path includes a circuit switched path; wherein each ingress network element has a control unit, for receiving a data packet belonging to a data packet flow and providing the data packet to a selected optical path in view of at least one parameter selected from the group consisting of: (i) the data packet flow; (ii) the ingress network element that received the data packet; (iii) the destination of the data packet; (iv) at least one predefined criterion.

33. The network of claim 32 wherein the network control unit is configured to allocate wavelengths to circuits switch paths.

34. The network of claim 32 wherein the control unit is further configured to: (a) analyze incoming data packets to determine to which packet switched path to provide the data packet; (b) generate a label being indicative of the packet switched path; (c) attach the label to the data packet; and
wherein each intermediate network element along a packet switched path is configured to process the label and to send forward the label and the data packet across the intermediate network element accordingly.

35. The network of claim 32 wherein the control unit is further configured to: (a) analyze incoming data packets to determine to which circuit switched path to provide the data packet; (b) change the wavelength of the data packet to a predefined wavelength associated to the circuit switched path; and wherein each intermediate network element along a packet switched path is configured to detect the wavelength of the data packet and forward the data packet accordingly.

36. The network of claim 32 wherein ingress network elements are further adapted to configure network elements to support packet switched routing or support circuit switched routing in view of the load on optical paths across the network.

37. The network of claim 32 wherein ingress network elements are further configured to balance traffic load between optical paths starting at the ingress network elements.

38. The network of claim 32 wherein each packet switched path comprises of a plurality of local paths across network elements along the packet switched path; and wherein each network element has a local control component for selecting a local path across the network element.

39. The network of claim 32 wherein each network element is further configured to balance traffic load among local paths across the network element.
